(19) United States
(12) Patent Application Publication
(10) Pub. No.: US 2008/0274742 A1
(43) Pub. Date: Nov. 6, 2008

(54) METHOD FOR PERFORMING MOBILITY MEASUREMENTS AMONG DIFFERENT NETWORKS

(75) Inventor: HAO BI, LAKE ZURICH, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/743,506

(22) Filed: May 2, 2007

(51) Int. Cl. H04Q 7/20

(52) U.S. Cl. 455/437

(57) ABSTRACT

A mobile station (102) operating in a present serving cell (104) evaluates a candidate cell (108) for handover. The candidate cell is of a different air interface from the present serving cell, and thus the mobile station initially has no timing information regarding the candidate cell. To minimize measurement time away from the present serving cell, the mobile station first acquires timing information of the candidate cell (406). The timing information is used to generate a measurement gap profile (608). The measurement gap profile is used by the mobile station to configure a measurement pattern based on the timing of the serving cell to ensure reception of control information of the candidate cell.

### FIELD OF THE INVENTION

The invention relates generally to mobile communication, and more particularly to handover of a communication session from one air interface to a candidate cell operating according to a different air interface where the mobile station must make measurements of the candidate cell.

### BACKGROUND OF THE INVENTION

Mobile communications systems have become common in metropolitan regions of the world, and are used by a significant number of people for every day personal and business communication activity. Communication service is in such demand that a variety of systems using different protocols and air interfaces have become established and co-exist in many regions. The overlapping coverage of these systems provide people with a choice of operators. Furthermore, the abundance of coverage has allowed operators to partner with each other to offer customers wider coverage on other systems where the operator does not have coverage and other system operators do provide coverage. In addition, smaller systems have, in some places, been merged into other systems.

To take advantage of the variety of systems and coverage available, manufacturers of mobile devices have begun to design mobile devices with transceivers that are capable of operating in accordance with multiple air interfaces. Given that a mobile device can operate on multiple air interfaces, and that system operators can offer service to subscribers on various systems, it is desirable to make handover possible for a call from one system or air interface to another.

The prospect of handing over a call or communication session to a different air interface presents some issues. For example, mobility management becomes more complex as the candidate cell likely operates not only on a different frequency, but on one that is outside the allocated frequency band of the present serving network. Furthermore, the candidate handover cell may operate using a different air interface, having a different framing structure and different modulation. Furthermore, the present serving network may have no timing information regarding the signaling and framing of the candidate handover cell. Consequently, the mobile station must ascertain substantially more information from the candidate handover cell than if the mobile station were handing over to another cell of the present serving network.

In order to acquire the necessary information from the candidate cell, the mobile station must tune away from the present serving cell and listen to the candidate cell. By “tune away” it is meant that the mobile station changes or reconfigures the transceiver to operate in a different band, and may include changing the modulation scheme used. Periodically the mobile station must undertake a measurement of the candidate cell to determine if it remains a candidate cell, or if its rank as a candidate cell changes. Since the candidate cell may have a different time based frame structure, the mobile station may have to tune away from the present serving cell for long periods while it listens for particular information and control symbols. Tuning away from the present serving cell can be done during discontinuous receive operation, when mobile stops receiving data from present serving cell. That is, the present serving cell only transmits during particular time slots or frames, and during the other time the mobile station may listen to candidate cells. However, tuning away from the present serving cell and listening to candidate cells for long periods until the desired information is received tends to defeat the purpose of discontinuous reception, which is to save power. Furthermore, if the mobile station is engaged in a data session, then tuning away from the present serving cell reduces the reception time. Therefore there is a need for a way to perform the necessary mobility management but reduce the time away from the present serving cell.

### SUMMARY OF THE INVENTION

The present invention discloses in one embodiment a method of performing measurements on handover candidate cells in a multi-system mobile radio access network environment by a mobile station. The method commences by determining timing information of a candidate cell by the mobile station. This includes retuning a transceiver of the mobile station from the present serving network channel to receive a candidate cell channel and acquiring the timing information of the candidate cell channel. The timing information indicates a time base and framing of the candidate cell. The mobile station then commences sending the timing information to the present serving network, including retuning the transceiver of the mobile station from the candidate cell channel to the present serving network and transmitting the timing information to the present serving network. Once the present serving network has processed the information, it produces a measurement gap profile which is transmitted back to the mobile station. The mobile station, upon receiving the measurement gap profile, configures a measurement gap pattern for each measurement instance, with width, interval, and start time relative to the timing of the present serving network. The measurement gap pattern specifies at least one measurement gap which configured to occur during transmission of control information in the candidate cell channel. The mobile station then commences performing measurements of the candidate cell according to the measurement gap pattern.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a mobile communication system diagram including two systems;

FIG. 2 shows a timing and frame structure diagram for a E-UTRAN system;

FIG. 3 shows a timing and frame structure diagram for a GSM system;

FIG. 4 shows a flow chart diagram of a method of performing mobility measurements on neighboring cells, in accordance with an embodiment of the invention;

FIG. 5 shows a measurement gap pattern;

FIG. 6 shows a flow chart diagram of a method of configuring a measurement gap pattern profile, in accordance with an embodiment of the invention; and

FIG. 7 shows a signaling diagram of a method of performing inter-system mobility measurements in accordance with the invention; and

FIG. 8 shows a timing diagram of a measurement gap profile, a candidate cell channel, and a measurement gap pattern, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

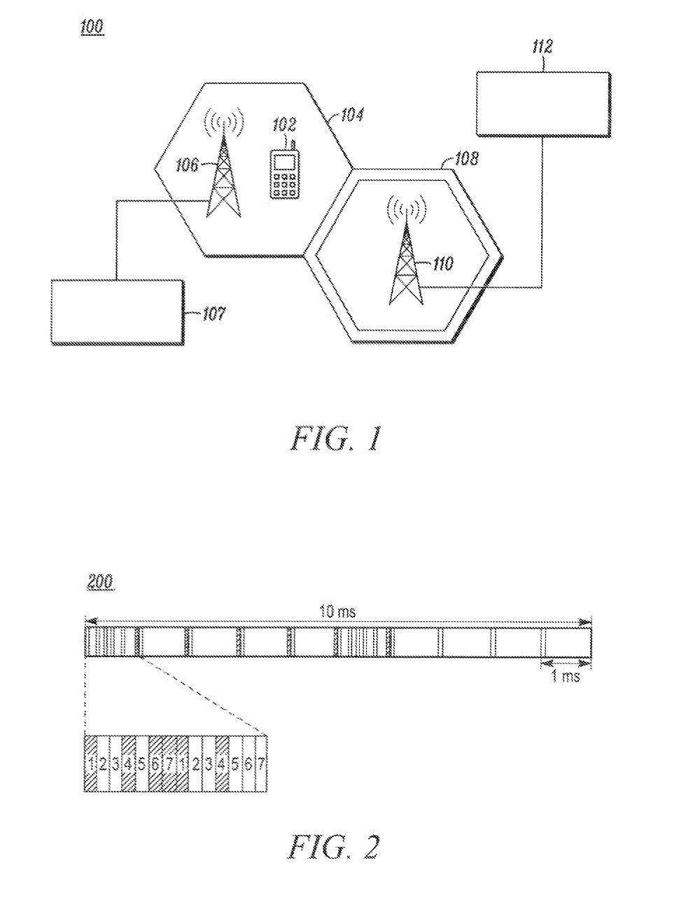

Referring now to FIG. 1, there is shown a mobile communication system diagram 100 including two systems, in accordance with an embodiment of the invention. A mobile communication device 102 is shown operating in a present serving cell 104. The present serving cell 104 is established in the radio vicinity of a base station 106. As used herein, term “cell” may refer to either the geographic area or region in which communication service is provided by a base station, or to the radio interface provided by the base station. Hence, for example, when a mobile device is “connected” to a cell, it is meant that the mobile device is interacting with a base station radio over an established radio interface within the geographic region serviced by the base station. The base station is coupled to a communications network 107, which may contain the various call processing, switching, and control & administration equipment, as is known in the art. The mobile communication device may be any sort of mobile station used for mobile communication, including, for example, cellular telephones, computers, and so on. Neighboring the present serving cell is a candidate handover cell 108. The candidate handover cell is facilitated by a base station 110, which is connected to a second communication network 112. The candidate cell 108 is operated on a frequency different than that of the present serving cell 104. Furthermore, the candidate cell may be operated according to a different radio or air interface. Although shown here as bordering the present serving cell, it is contemplated that, due to the different air interface and frequency of operation, there may be geographical overlap between the present serving cell and the candidate cell. According to the invention, the mobile communication device 102 may handover communication service to the candidate cell 108 from the present serving cell 104. However, because of the dissimilar air interface, and because the two cells may be operated by different networks, the mobile station faces difficulty in performing mobility management measurements as the mobile station may receive little, if any information from the present serving cell regarding the candidate cell.

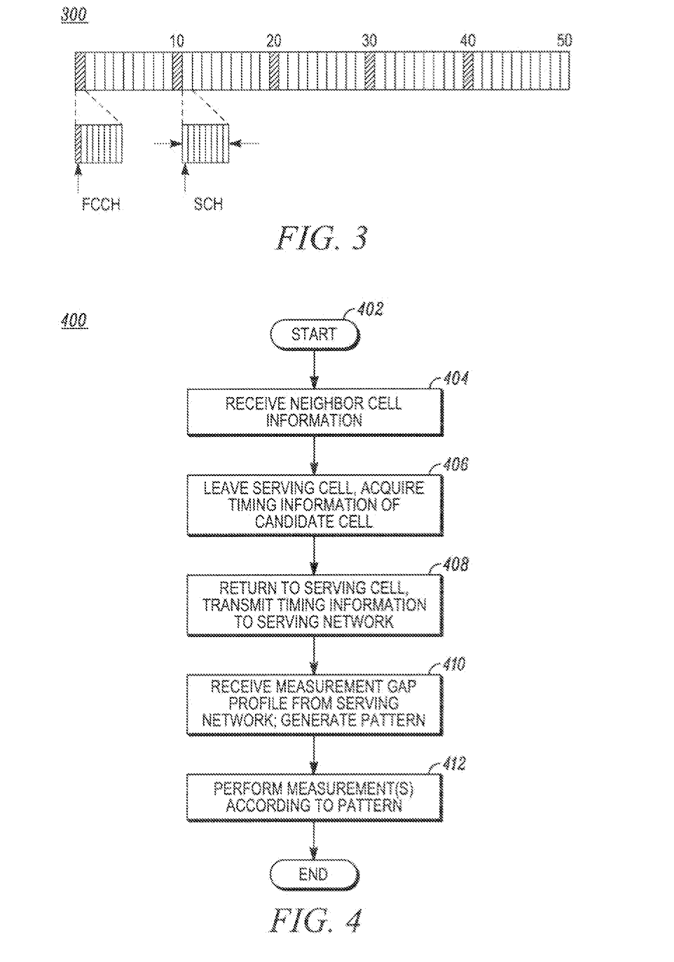

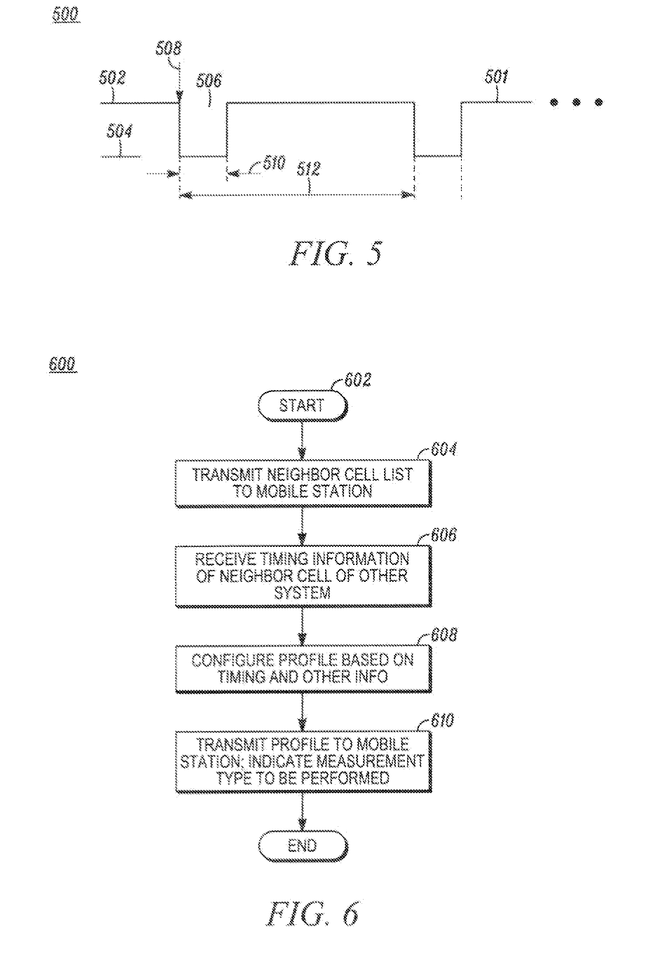

The difficulty can be demonstrated by a perusal of FIGS. 2 and 3, which show, respectively, a timing and frame structure diagram 200 for a system operated in accordance with the Evolved Universal Terrestrial Radio Access Network (E-UTRAN) specification, and a timing and frame structure diagram 300 for a system operated in accordance with the Global System for Mobile communications (GSM) specification. The E-UTRAN system uses radio frame of 1 s duration, each having 10 subframes of 1 ms duration and containing 2 slots of 0.5 ms with 7 OFDM symbols per slot. To evaluate the radio interface for handover purposes a mobile station must receive certain downlink reference signals which occur in specified time slots. The Primary Synchronization Channel (P-SCH) and Secondary Synchronization Channel (S-SCH) are transmitted 2 times per radio frame in its 1^{st} and 6^{th} subframes (subframes 0 and 5). The Primary Synchronization Signal (PSS) and Secondary Synchronization Signal (SSS) are time multiplexed on the 7^{th} and 6^{th} OFDM symbols, respectively. Two sets of reference symbols (RS), 1^{st} downlink (DL) RS (RS0) and 2^{nd} downlink RS (RS1), can be present in a subframe. For all subframes, at least RS0 is present in the 1^{st} OFDM symbol of each slot. For subframes 0 and 5, RS1 is also present in the 4^{th} OFDM symbol of a slot. Hence, subframes 0 and 5 have both reference symbols RS0 and RS1 for measurements. The GSM systems broadcast control channel (BCCH) provides a frame of 60/13 ms with 8 slots. A frequency correction channel (FCCH) and a timing synchronization channel (SCH) are broadcast in the first slots of two neighboring frames every 10 frames for cell acquisition and identification. Thus, it can be seen that the two systems use a different time base. Furthermore, the cells in these two systems may be asynchronous, i.e., they may not have their reference times synchronized to each other. Therefore, there will be a changing time offset between, for example, the start of a frame in one system to the start of the next occurring frame in the other system. In order to ensure reception of the necessary information on right time slots/frames for mobility management measurements, a mobile device having no timing information of a candidate cell using a different air interface may have to leave its present serving cell for an extended period of time, waiting for the occurrence of the necessary information. As used here, the term “leave” means that the mobile station retunes its transceiver to receive the candidate cell signal, rather than signals transmitted by the present serving cell. Since critical mobility management is performed during a call or communication session, it is desirable to reduce the time away from the present service cell.

Referring now to FIG. 4, there is shown a flow chart diagram 400 of a method of performing mobility measurements on neighboring cells, in accordance with an embodiment of the invention. At the start 402 the mobile station is being serviced by a present serving cell, and has found that the received signal strength is degrading. It is contemplated that the method illustrated here is performed during a call or communication session, which may include receiving data or messaging information. It is further contemplated that the present serving cell may be programmed with knowledge of a neighbor cell operated by another communication network. The information regarding other neighbor cells, such as the frequencies at which they are operating, maybe provided to the mobile station using signaling message, e.g., in a neighbor cell information message (404). According to the invention, the mobile station first leaves the present serving cell for a short time in order to acquire timing information of the candidate cell (406). Leaving the present serving cell involves reconfiguring the transceiver of the mobile station to conform to the air interface of the candidate cell. It should be noted that at this point, the mobile station is only receiving the candidate channel long enough to determine its present timing, which may include a present slot number, the time of occurrence of the start of a frame, and so on. The mobile station may record this timing information relative to a present frame time of the present serving cell by maintaining appropriate timers.

Once the timing information is acquired, the mobile station then returns to the present serving cell, and transmits the timing information to the present serving network (408). It is further contemplated that the mobile station may also include information regarding its own measurement capabilities, such as the time needed to process control information. Additionally, it is contemplated that the mobile station may transmit information regarding more than one candidate cell.

Upon reception of the timing information of the candidate cell, the present serving network is configured to evaluate the information, along with the mobile station's measurement capability, if provided, and configure a measurement gap profile. The measurement gap profile specifies a series of measurement gaps during which the mobile station is to leave the present serving network to make mobility-related measurements of the candidate cell on certain time slots/frames. The series of measurement gaps are scheduled to occur at a time when the desired information will occur in the candidate cell channel in corresponding time slots/frames, and is specified by a start time relative to the time base of the present serving network, a minimum gap width or duration unit, and a gap period if the measurement is to be repeated at a series of time instances in the future. Gap period may be defined using the time base or frame structure of the candidate cell. Furthermore, the measurement gap profile may specify more than one candidate cell to be measured during the gap, or specify different candidate cells in different gaps. The present serving network may also indicate what type of measurement to perform in a particular specified gap. In addition to the timing of the candidate cell, and the measurement capability of the mobile station, the present serving network may further schedule the measurement gap based on the outgoing data to the mobile station to preserve a desired quality of service level.

Once the measurement gap profile is generated, it is transmitted to the mobile station (410). Upon receiving the measurement gap profile, the mobile station may then configure a measurement gap pattern for measurements at those scheduled time instances by determining their gap starting points, their widths in the multiples of minimum gap units, and their separation intervals from adjacent measurement instances. The gap starting points, widths, and gap separation intervals are calculated based on the received gap profile for each measurement instance.

For each measurement instance, the mobile station determines the time slot/frame of the candidate cell to be measurement based on the parameters of the gap profile, e.g., based on the measurement gap series' starting point and its gap period. The mobile station then maps the time slot/frame to be measured in the candidate cell to the time base or frame structure of the serving cell. The mobile station then determines the gap width in the multiples of minimum gap units, depending whether the time slot/frame to be measured in the candidate cell falls within one minimum gap unit or not. If the time slot/frame to be measured in the candidate cell falls within one minimum gap unit, the gap width for this measurement instance can be set to one. If the time slot/frame to be measured in the candidate cell falls on the boundaries of multiple minimum gap units, the gap width for this measurement instance can be set to a multiple of minimum gap units.

Hence, the gap widths and starting times may be different from measurement instance to measurement instance. After the mobile station determines which time slots/frames in the serving cell are to be used for measurement of the candidate cell, the gap separation interval of a gap profile can be calculated accordingly by using the locations of those slots/frames in the serving cell to be occupied by measurement gaps in those measurement instances. The gap separation interval may be different from measurement instance to measurement instance, due to the relative time base or slot/frame structure offset between the serving cell and candidate cell for measurement. Thus, it will be appreciated by those skilled in the art that the measurement gap profile generated by the network is a guide as to when the gaps occur, but the mobile station can adjust the width and specific starting time to account for the differences in time base between the present serving cell and the candidate cell, where the start of the information needed to be received from the candidate cell occurs slightly earlier, or lasts beyond the gap as configured in the measurement gap profile.

The mobile station may then commence performing the scheduled measurements in the indicated times of the measurement gap profile (412). The method may be repeated as necessary, and it is contemplated that the present serving network may adjust the measurement gap profile from time to time to change the measurement made by the mobile station.

Referring now to FIG. 5, there is shown a measurement gap pattern 500 as is specified according to the invention by the present serving network. The timing line 501 varies between a high side 502 and a low side 504. The high side indicates time when the mobile station is available in the present serving cell, and the low side indicates time when the mobile station is away from the present serving cell to perform scheduled measurements of the candidate cell. The measurement gap is specified by a start time 508, and gap width 510, and a gap interval 512 in the measurement gap pattern. It is contemplated that these gap pattern parameters may be provided in terms of minimum scheduling units of the present serving cell, such as subframe units, for example. As indicate in reference to FIG. 4, the pattern as shown here may be adjusted by the mobile station to produce a measurement gap pattern that accounts for the differences in time base among the cells.

Referring now to FIG. 6, there is shown a flow chart diagram 600 of a method of scheduling a gap profile for a series of measurements and configuring a measurement gap pattern for each one of the measurement instances, in accordance with an embodiment of the invention. According to the invention, the present serving network performs the task of configuring the measurement gap profile for a series of measurements based on information it has, and information it received from the mobile station. As with FIG. 4, the method here starts 602 with the mobile station presently affiliated with the present serving network. It is intended that the mobile station is engaged in a call or communication session with the present serving network during commencement of the method, but the method may be used when no call or communication session is occurring as well. The present serving cell may, upon commencing service with the mobile station, provide neighbor cell information (604) to the mobile station. The neighbor cell information may identify cells outside of the present serving network, if known, although it is contemplated that the method may be commenced without the mobile station having any knowledge of surrounding cells of other networks. The mobile station, as discussed in reference to FIG. 4, leaves the present serving cell to find timing information of a candidate cell. The mobile station may use information in the neighbor list, if provided, or it may be found through a discovery procedure. Once the timing information is acquired, it is transmitted to the present serving network by the mobile station (606). Furthermore, the mobile station may provide its measurement capability to the present serving network to be used in scheduling the measurement gap profile.

Upon receiving the information from the mobile station, the present serving network configures the measurement gap profile based at least in part on the timing information of the candidate cell provided by the mobile station (608). Other information may be used, such as, for example, the amount of outbound data buffered at the present serving network for the mobile station. Once the measurement gap profile parameters, including the starting point, the minimum gap unit, and the measurement period or interval, are selected, the present serving network creates a measurement gap profile. The profile is in the form of a file or message, and including the necessary gap profile parameters. The present serving network then transmits the measurement gap profile information to the mobile station (610). Once the mobile station receives the gap profile to the mobile station. The mobile station uses the measurement gap profile to configure a measurement gap pattern for each measurement instance by deriving the starting point, width in the multiples of minimum gap units, separation interval from adjacent gaps for each measurement instance. The method may be repeated from time to time to indicate different types of measurements to be performed, and adjusting of the gap to allow for various measurements.

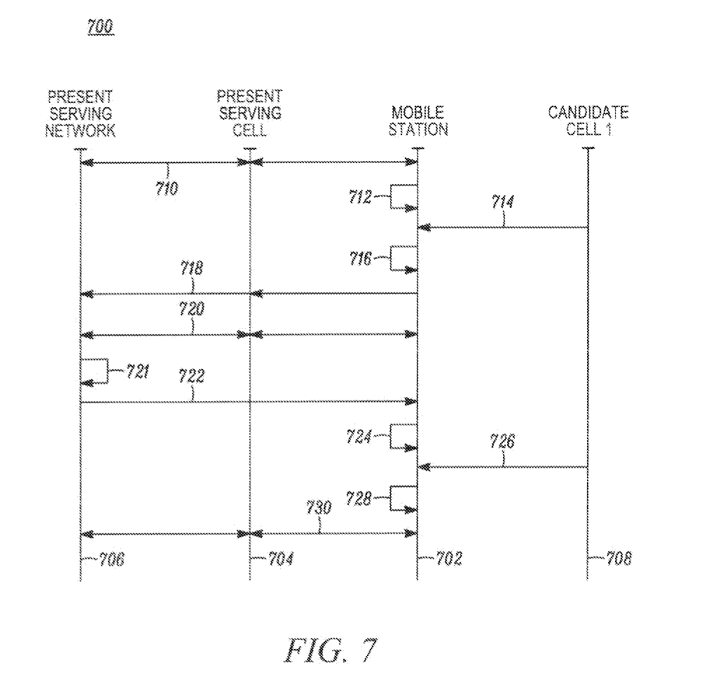

Referring now to FIG. 7 there is shown a signaling diagram 700 of a method of performing inter-system mobility measurements in accordance with the invention. The diagram has vertical lines representing the mobile station 702, present serving cell 704, present serving network 706, and the candidate cell 708.

Upon commencement of the method in the present example, the mobile station is engaged in a call or communication session 710 with the present network via the present serving cell. The mobile station may be geographically located where there are no more cells affiliated with the present serving network to which service may be handed if the signal conditions degrade sufficiently. Consequently, the service may have to be handed over to a cell not affiliated with present serving network, or one operating according to a different air interface which is operated by the same operator of the present serving network. To find a candidate cell and acquire timing information, the mobile station must leave the present serving cell and retune 712 to discover, and/or receive the candidate channel 714. By retune, it is meant that the mobile station changes the frequency of operation of its transceiver, and may also change the modulation scheme used by the transceiver. This is performed just long enough to acquire the necessary timing information, which will likely be much shorter than the time needed to find all the control information necessary to connect to a candidate cell. Once the timing information is acquired, the mobile station retunes 716 back to the present serving cell.

Once back on the present serving cell, the mobile station transmits the timing information to the present serving network via the present serving cell 718, and commences with the call or data session 720. The present serving network uses the timing information to generate the measurement gap profile for a series of measurements 721. The measurement gap profile is then transmitted to the mobile station 722.

The mobile station then configures a measurement gap pattern for each measurement instance, using the measurement gap profile as a guide, by deriving starting point, width and interval for each measurement instance, based on the time base units of the present serving cell. The pattern therefore accounts of instances where the control information of the candidate cell which is to be received starts before the gap, or which lasts beyond a gap as specified by the measurement gap profile. By adjusting the start time, width, and interval, the mobile station ensures that it will receive the desired control information of the candidate cell necessary to make the mobility measurement.

The mobile station accordingly retunes at the appropriate time indicated by the measurement gap profile with corresponding gap pattern for each measurement instance 724, and commences listening or receiving the candidate channel 726 during the patterned measurement gap. The information received during the patterned measurement gap allows the mobile station to measure the candidate channel signal for mobility purposes, such as, for example, deciding when to request a handover to the candidate channel, or when to downgrade the candidate cell to a non-candidate cell.

Upon completing the measurement, the mobile station again retunes 728 and recommences service on the present serving network 730. The measurements may be repeated for a series of time instances as indicated by the measurement gap profile with corresponding gap patterns.

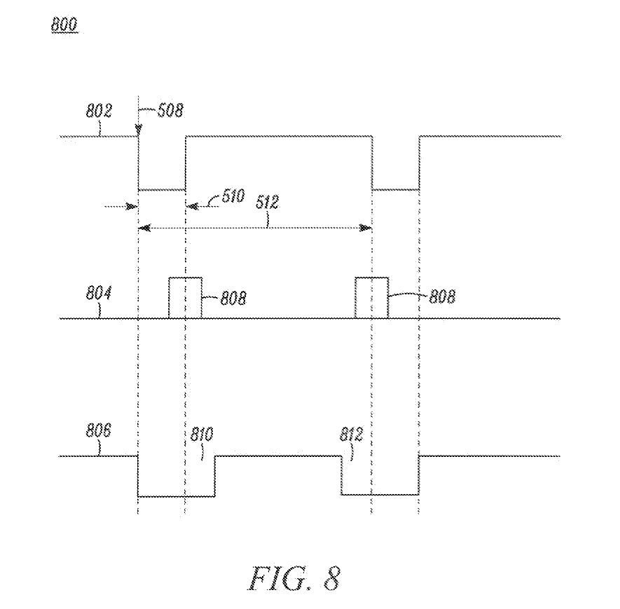

Referring now to FIG. 8, there is shown a timing diagram 800 of a snap shot of a measurement gap profile at a couple of measurement instances 802 converted into the time base of the serving cell, a candidate cell channel 804, and a measurement gap pattern 806, in accordance with an embodiment of the invention. The measurement gap profile is substantially the same as that illustrated in FIG. 5, and indicates a start time 508, width 510, and interval or period 512. These parameters are specified in terms of the time base of the serving cell. The candidate cell channel includes control frames 808 which occur at times offset from the time base of the present serving cell since the candidate cell uses a different time base due to it being operated according to a different air interface. As it can be seen, if the measurement gap profile were strictly followed for making measurements, the mobile station would miss portions of the control frames of the candidate cell channel. Accordingly, the measurement gap pattern adjusts the measurement gaps 810, 812 to ensure complete reception of the control frames. The measurement gaps are adjusted as necessary in each measurement gap instance, as necessary to ensure the mobile station has time to receiver the entire control frame of the candidate cell channel.

This invention can be embodied in other forms without departing from the spirit or essential attributes thereof. Accordingly, reference should be made to the following claims, rather than to the foregoing specification, as indicating the scope of the invention.

What is claimed is:

1. A method of performing measurements on handover candidate cells in a multi-system mobile radio access network environment by a mobile station, comprising:
determining timing information of the candidate cell, including retuning a transceiver of the mobile station from a present serving network channel to receive a candidate cell channel and acquiring the timing information of the candidate cell channel, the timing information indicating a time base and framing of the candidate cell;
sending the timing information to the present serving network including retuning the transceiver of the mobile station from the candidate cell channel to the present serving network and transmitting the timing information to the present serving network;
receiving from the present serving network a measurement gap profile, the measurement gap profile being produced by the present serving network and at least in part based on the timing information received from the mobile station, the measurement gap profile specifying a starting point, a minimum measurement gap unit, and measurement period;
configuring a measurement gap pattern for each measurement instance with width, interval, and start time relative to a timing of the present serving network, the measurement gap pattern specifying at least one measurement gap, and wherein the at least one measurement gap is configured to occur during transmission of control information in the candidate cell channel; and
performing a measurement of the candidate cell according to the measurement gap profile with appropriate measurement gap pattern.

2. A method of performing measurements on handover candidate cells as defined in claim 1, further comprising: receiving a neighbor cell information including the candidate cell prior to determining timing information of the candidate cell, and wherein the neighbor cell information is used by the mobile station to find the candidate cell channel.

3. A method of performing measurements on handover candidate cells as defined in claim 1, further comprising sending a measurement capability to the present serving network with the timing information, and wherein the measurement gap pattern profile is configured further in view of the measurement capability of the mobile station.

4. A method of performing measurements on handover candidate cells as defined in claim 1, wherein the measurement gap profile further contains a measurement type to indicate a type of measurement to be performed during the measurement gap.

5. A method of performing measurements on handover candidate cells as defined in claim 1, wherein configuring the measurement gap pattern comprises adjusting the measurement gaps to ensure complete reception of a control frame of the candidate channel.

6. A method of performing measurements on handover candidate cells as defined in claim 5, wherein adjusting the measurement gaps comprises adding at least one scheduling unit of time of the present serving cell to the measurement gap.

7. A method of generating a measurement gap profile for a mobile station operating in a multi-system mobile radio access network environment, comprising:
receiving from the mobile station, at a present serving network, timing information of a handover candidate cell identified by the mobile station, the candidate cell belonging to a network other than the present serving network;
configuring the measurement gap profile at the present serving network, specifying a measurement gap start time, minimum gap width unit, and measurement period based at least in part on the timing information of the handover candidate cell; and
transmitting the measurement gap profile to the mobile station from the present serving network; and
wherein the measurement gap profile is used to generate a measurement gap pattern at the mobile station, and wherein the measurement gap pattern is configured to adjust the measurement gaps to ensure complete reception of a control frame of the candidate channel.

8. A method of generating a measurement gap profile as defined in claim 7, further comprising receiving, as the present serving network, a measurement capability of the mobile station; and
wherein configuring the measurement gap profile includes specifying at least the measurement gap width further based on the measurement capability of the mobile station.

9. A method of generating a measurement gap profile as defined in claim 7, wherein transmitting the measurement gap pattern profile further includes transmitting a measurement type to be performed by the mobile station on the candidate cell.

10. A method of generating a measurement gap profile as defined in claim 7, further comprising transmitting a neighbor cell information to the mobile station identifying the candidate cell, performed prior to receiving the timing information.

11. A method of generating a measurement gap pattern as defined in claim 7, wherein the measurement gap width, interval, and start time are specified in terms of slot of frame units of the present serving network.

12. A method of generating a measurement gap profile as defined in claim 7, wherein transmitting the measurement gap profile is transmitting a first measurement gap profile, the method further comprises:
configuring a second measurement gap profile having at least a measurement gap width that is different than the first measurement gap profile, based upon a second measurement type to be performed; and
subsequent to transmitting the first measurement gap profile, transmitting the second measurement gap profile to the mobile station.

13. A method of conducting a measurement of a handover candidate cell by a mobile station operating in a present serving cell of a present serving network, the handover candidate cell operating at a different frequency and timing base from the present serving cell, the method comprising:
acquiring, by the mobile station, timing information of the candidate cell, including retuning a transceiver of the mobile station from a present operating frequency to a frequency of the candidate cell and receiving a channel of the candidate cell;
transmitting to the present serving network via the present serving cell the timing information of the candidate cell, including tuning the transceiver of the mobile station to the present operating frequency of the present serving cell;
configuring, at the present serving network, a measurement gap profile indicating a gap starting time, minimum gap width unit, and measurement period, based at least in part on the timing information for a series of measurement gaps;
transmitting the measurement gap profile to the mobile station from the present serving network;
configuring a measurement gap pattern based on the measurement gap profile, the measurement gap pattern configured to adjust the measurement gaps to ensure complete reception of a control frame of the candidate channel; and
conducting a measurement of the candidate cell according to the measurement gap profile with the corresponding measurement gap pattern at the mobile station.

14. A method of conducting a measurement of a handover candidate cell as defined in claim 13, further comprising transmitting a neighbor cell information including the candidate cell prior to acquiring the timing information of the candidate cell, and wherein the neighbor cell information is used by the mobile station to find the candidate cell channel.

15. A method of conducting a measurement of a handover candidate cell as defined in claim 13, further comprising transmitting a measurement capability of the mobile station to the present serving network with the timing information, and wherein the measurement gap profile is configured further in view of the measurement capability of the mobile station.

16. A method of conducting a measurement of a handover candidate cell as defined in claim 13, wherein the measurement gap profile further contains a measurement type to indicate a type of measurement to be performed during the measurement gap.

17. A method of conducting a measurement of a handover candidate cell as defined in claim 13, wherein width, interval, and start time of a measurement gap pattern are specified in terms of slot or frame units of the present serving network.

18. A method of conducting a measurement of a handover candidate cell as defined in claim 13, wherein the candidate cell channel is a broadcast control channel.

19. A method of conducting a measurement of a handover candidate cell as defined in claim 13, wherein the candidate cell uses an air interface that is different than the present serving cell.

20. A method of conducting a measurement of a handover candidate cell as defined in claim 13, wherein conducting the measurement of the candidate cell according to the measurement gap profile includes adjusting the gap pattern based on timing units of the present serving cell.
